(19) United States
(12) Patent Application Publication
(10) Pub. No.: US 2022/0283857 A1
(43) Pub. Date: Sep. 8, 2022

(54) ENABLING DYNAMIC MOBILE DEVICE USAGE SUGGESTIONS

(71) Applicant: LENOVO (Singapore) PTE. LTD., New Tech Park (SG)

(72) Inventors: John C. Mese, Cary, NC (US); Nathan J. Peterson, Oxford, NC (US); Arnold S. Weksler, Raleigh, NC (US); Russell Speight VanBlon, Raleigh, NC (US); Mark Patrick Delaney, Raleigh, NC (US)

(21) Appl. No.: 17/191,364

(22) Filed: Mar. 3, 2021

(51) Int. Cl. G06F 9/50

(52) U.S. Cl. CPC G06F 9/505

(57) ABSTRACT

Apparatuses, methods, systems, and program products are disclosed for dynamic mobile device resource management. An apparatus includes a processor and a memory that stores code executable by the processor. The code is executable by the processor to determine a current usage rate of a constrained resource of an electronic device based on a user's activity on the electronic device, forecast a remaining utility of the constrained resource based on the current usage rate and historical usage of the electronic device, and take an action related to the constrained resource in response to the forecasted remaining utility of the constrained resource satisfying a utility threshold.

### FIELD

The subject matter disclosed herein relates to computing devices and more particularly relates to dynamic mobile device resource management.

### BACKGROUND

Computing devices have limited amounts of resources for use in executing programs, running operating systems, processing data, or the like. A user may not be aware of the amount of the resources that are remaining while the user is using a computing device.

### BRIEF SUMMARY

Apparatuses, methods, systems, and program products are disclosed for dynamic mobile device resource management. An apparatus, in one embodiment, includes a processor and a memory that stores code executable by the processor. In certain embodiments, the code is executable by the processor to determine a current usage rate of a constrained resource of an electronic device based on a user's activity on the electronic device, forecast a remaining utility of the constrained resource based on the current usage rate and historical usage of the electronic device, and take an action related to the constrained resource in response to the forecasted remaining utility of the constrained resource satisfying a utility threshold.

A method for dynamic mobile device resource management, in one embodiment, includes determining, by a processor, a current usage rate of a constrained resource of an electronic device based on a user's activity on the electronic device, forecasting a remaining utility of the constrained resource based on the current usage rate and historical usage of the electronic device, and taking an action related to the constrained resource in response to the forecasted remaining utility of the constrained resource satisfying a utility threshold.

A computer program product for dynamic mobile device resource management, in one embodiment, includes a computer readable storage medium having program instructions embodied therewith. In certain embodiments, the program instructions are executable by a processor to determine a current usage rate of a constrained resource of an electronic device based on a user's activity on the electronic device, forecast a remaining utility of the constrained resource based on the current usage rate and historical usage of the electronic device, and take an action related to the constrained resource in response to the forecasted remaining utility of the constrained resource satisfying a utility threshold.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for dynamic mobile device resource management;

FIG. 2 is a schematic block diagram illustrating one embodiment of an apparatus for dynamic mobile device resource management;

FIG. 3 is a schematic flow chart diagram illustrating one embodiment of another apparatus for dynamic mobile device resource management;

FIG. 4 is a schematic flow chart diagram illustrating one embodiment of a method for dynamic mobile device resource management; and

FIG. 5 is a schematic flow chart diagram illustrating one embodiment of another method for dynamic mobile device resource management.

### DETAILED DESCRIPTION

As will be appreciated by one skilled in the art, aspects of the embodiments may be embodied as a system, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to emphasize their implementation independence more particularly. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

An apparatus, in one embodiment, includes a processor and a memory that stores code executable by the processor. In certain embodiments, the code is executable by the processor to determine a current usage rate of a constrained resource of an electronic device based on a user's activity on the electronic device, forecast a remaining utility of the constrained resource based on the current usage rate and historical usage of the electronic device, and take an action related to the constrained resource in response to the forecasted remaining utility of the constrained resource satisfying a utility threshold.

In one embodiment, the action comprises displaying the forecasted remaining utility of the constrained resource in response to the forecasted remaining utility satisfying the utility threshold.

In one embodiment, the action comprises generating a warning that the forecasted remaining utility will satisfy the utility threshold within a calculated amount of time based on the current usage rate of the user's activity on the electronic device.

In one embodiment, the action comprises displaying at least one suggestion for modifying the user's activity on the electronic device to preserve the utility of the constrained resource.

In one embodiment, the at least one suggestion is determined based on at least one of the user's location, an upcoming event determined from a calendar, and trends in the user's previous actions related to the constrained resource.

In one embodiment, the code is executable by the processor to prevent taking the action in response to determining that an interruption exception is set for the user's activity on the electronic device.

In one embodiment, the action comprises identifying and presenting at least one different device to continue the user's activity in response to the forecasted remaining utility of the constrained resource satisfying the utility threshold.

In one embodiment, the code is executable by the processor to provide the current usage rate to a machine learning that is trained on the historical usage of the electronic device to forecast the remaining utility of the constrained resource.

In one embodiment, the constrained resource comprises at least one of battery life for the electronic device and network data usage for the electronic device.

In one embodiment, the utility threshold comprises a network data usage threshold and the action comprises at least one of presenting a different network to connect to, presenting a summary of an amount of network data used as compared to network data available, and modifying the user's activity such that less network data is consumed.

In one embodiment, the utility threshold comprises a battery usage threshold and the action comprises at least one of modifying at least one setting on the electronic device such that it uses less battery, pausing the user's activity on the electronic device, and notifying the user of a remaining battery life based on the current usage rate.

A method for dynamic mobile device resource management, in one embodiment, includes determining, by a processor, a current usage rate of a constrained resource of an electronic device based on a user's activity on the electronic device, forecasting a remaining utility of the constrained resource based on the current usage rate and historical usage of the electronic device, and taking an action related to the constrained resource in response to the forecasted remaining utility of the constrained resource satisfying a utility threshold.

In one embodiment, the action comprises displaying the forecasted remaining utility of the constrained resource in response to the forecasted remaining utility satisfying the utility threshold.

In one embodiment, the action comprises generating a warning that the forecasted remaining utility will satisfy the utility threshold within a calculated amount of time based on the current usage rate of the user's activity on the electronic device.

In one embodiment, the action comprises displaying at least one suggestion for modifying the user's activity on the electronic device to preserve the utility of the constrained resource. The at least one suggestion may be determined based on at least one of the user's location, an upcoming event determined from a calendar, and trends in the user's previous actions related to the constrained resource.

In one embodiment, the method includes preventing taking the action in response to determining that an interruption exception is set for the user's activity on the electronic device.

In one embodiment, the action comprises identifying and presenting at least one different device to continue the user's activity in response to the forecasted remaining utility of the constrained resource satisfying the utility threshold.

In one embodiment, the method includes providing the current usage rate to a machine learning that is trained on the historical usage of the electronic device to forecast the remaining utility of the constrained resource.

In one embodiment, the constrained resource comprises at least one of battery life for the electronic device and network data usage for the electronic device. The utility threshold may include a network data usage threshold and the action comprises at least one of presenting a different network to connect to, presenting a summary of an amount of network data used as compared to network data available, and modifying the user's activity such that less network data is consumed.

The utility threshold may include a battery usage threshold and the action comprises at least one of modifying at least one setting on the electronic device such that it uses less battery, pausing the user's activity on the electronic device, and notifying the user of a remaining battery life based on the current usage rate.

A computer program product for dynamic mobile device resource management, in one embodiment, includes a computer readable storage medium having program instructions embodied therewith. In certain embodiments, the program instructions are executable by a processor to determine a current usage rate of a constrained resource of an electronic device based on a user's activity on the electronic device, forecast a remaining utility of the constrained resource based on the current usage rate and historical usage of the electronic device, and take an action related to the constrained resource in response to the forecasted remaining utility of the constrained resource satisfying a utility threshold.

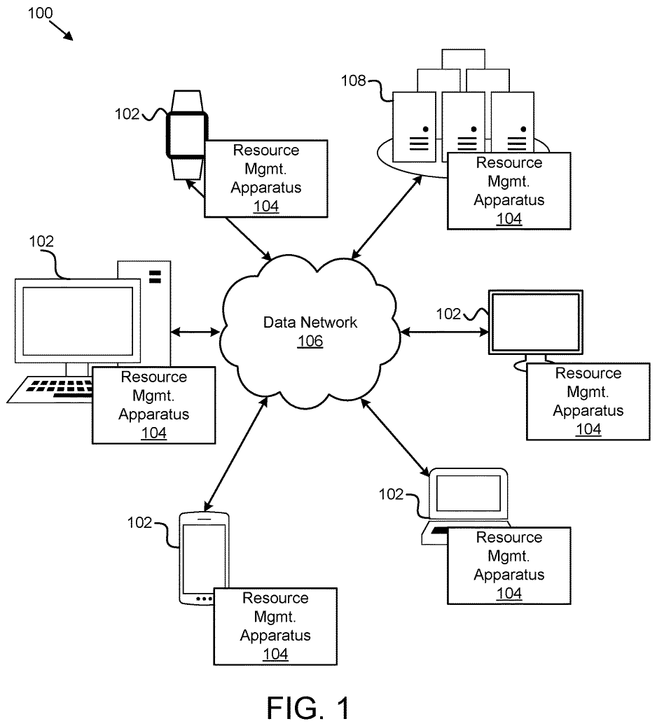

FIG. 1 is a schematic block diagram illustrating one embodiment of a system 100 for dynamic mobile device resource management. In one embodiment, the system 100 includes one or more information handling devices 102, one or more resource management apparatuses 104, one or more data networks 106, and one or more servers 108. In certain embodiments, even though a specific number of information handling devices 102, resource management apparatuses 104, data networks 106, and servers 108 are depicted in FIG. 1, one of skill in the art will recognize, in light of this disclosure, that any number of information handling devices 102, resource management apparatuses 104, data networks 106, and servers 108 may be included in the system 100.

In one embodiment, the system 100 includes one or more information handling devices 102. The information handling devices 102 may be embodied as one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, head phones, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

In general, in one embodiment, the resource management apparatus 104 is configured to determine a current usage rate of a constrained resource of an electronic device based on a user's activity on the electronic device, forecast a remaining utility of the constrained resource based on the current usage rate and historical usage of the electronic device, and take an action related to the constrained resource in response to the forecasted remaining utility of the constrained resource satisfying a utility threshold.

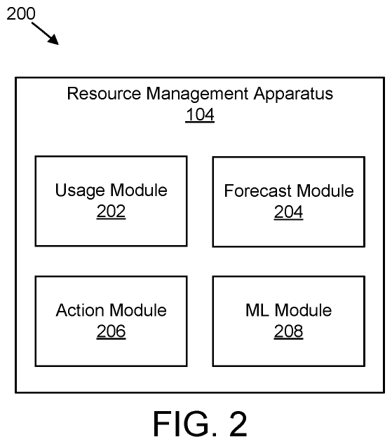

In this manner, the resource management apparatus 104 dynamically monitors the usage of constrained resources, e.g., a battery, network data, system memory, system storage, or the like, of a device, e.g., a smart phone, tablet computer, smart watch, laptop computer, or the like, and take, suggest, recommend, or the like an action to take to adjust or modify the rate in which the constrained resource is used. The resource management apparatus 104 is described in more detail below with reference to FIG. 2.

In certain embodiments, the resource management apparatus 104 may include a hardware device such as a secure hardware dongle or other hardware appliance device (e.g., a set-top box, a network appliance, or the like) that attaches to a device such as a head mounted display, a laptop computer, a server 108, a tablet computer, a smart phone, a security system, a network router or switch, or the like, either by a wired connection (e.g., a universal serial bus (“USB”) connection) or a wireless connection (e.g., Bluetooth®, Wi-Fi, near-field communication (“NEC”), or the like); that attaches to an electronic display device (e.g., a television or monitor using an HDMI port, a DisplayPort port, a Mini DisplayPort port, VGA port, DVI port, or the like); and/or the like. A hardware appliance of the resource management apparatus 104 may include a power interface, a wired and/or wireless network interface, a graphical interface that attaches to a display, and/or a semiconductor integrated circuit device as described below, configured to perform the functions described herein with regard to the resource management apparatus 104.

The resource management apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the resource management apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the resource management apparatus 104.

The semiconductor integrated circuit device or other hardware appliance of the resource management apparatus 104, in certain embodiments, includes and/or is N communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the resource management apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”) (e.g., a home network), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102 and may be configured to execute or run machine learning algorithms, programs, applications, processes, and/or the like.

FIG. 2 is a schematic block diagram illustrating one embodiment of an apparatus 200 for dynamic mobile device resource management. In one embodiment, the apparatus 200 includes an instance of a resource management apparatus 104. In one embodiment, the resource management apparatus 104 includes one or more of a usage module 202, a forecast module 204, an action module 206, and an ML module 208, which are described in more detail below.

In one embodiment, the usage module 202 is configured to determine a current usage rate of a constrained resource of an electronic device based on a user's activity on the electronic device, e.g., a user's usage of an information handling device 102, a computing device, a mobile device, and/or the like. As used herein, a usage rate of a constrained resource may refer to an amount of a constrained resource that is used over a period of time based on current processes, programs, services, or the like that are executing on the electronic device. A constrained resource, as used herein, may refer to a resource of an electronic device that has a limited amount such as the remaining battery life for a battery, an amount of network data that is available until a data cap is reached, an amount of free memory or free storage space, an amount of available processing capacity, and/or the like.

In one embodiment, the usage module 202 may monitor the user's current activity on the electronic device. For instance, the usage module 202 may monitor applications, programs, or the like that the user is currently interacting with/using, that are running in the background, and/or the like. The usage module 202 may monitor, for example, an amount of battery life that an application is consuming, an amount of network data that the application is using, the amount of memory, storage, and/or processor cycles that the application is using, and/or the like, for a period of time, e.g., during a rolling five-minute window, during the last one minute, during the last thirty seconds, and/or the like.

In one embodiment, the usage module 202 may track, store, record, and/or the like usage characteristics describing the user's usage over a period of time, e.g., for the past day, week, month, and/or the like. The usage module 202 may track when (e.g., days, times, or the like that the user uses the electronic device) and/or for how long applications are used, including the resource usage characteristics of each application such as average/minimum/maximum amounts of resources that are used, e.g., battery, network data, memory, storage, processor, and/or the like. As described below, the usage characteristics of the applications may be used to train a machine learning model (using historical usage data) and/or may be used as inputs into a trained machine learning model (e.g., using current usage data).

In one embodiment, the forecast module 204 is configured to forecast a remaining utility of the constrained resource based on the current usage rate and historical usage of the electronic device. As used herein, the remaining utility may refer to a remaining life (e.g., battery life), a remaining amount until a cap is hit (e.g., a network data cap), a remaining capacity (e.g., memory space, storage space, processing cycles), and/or the like. The forecast module 204, in one embodiment, may calculate trends, estimates, and/or the like using statistical models, algorithms, and/or the like for the remaining utility of the constrained resources based on historical usage and current usage rates of the electronic device. In some embodiments, the forecast module 204 determines resource usage forecasts using machine learning/artificial intelligence, as explained in more detail below.

In one embodiment, the action module 206 is configured to take an action related to the constrained resource in response to the forecasted remaining utility of the constrained resource satisfying a utility threshold. As used herein, an action may be an automated action to restrict, limit, or the like usage of constrained resources to conserve the remaining utility of the constrained resources. Other actions may include providing recommendations, suggestions, advice, tips, notifications, and/or other guidance that a user can take to conserve the remaining utility of the constrained resource.

The utility threshold, as used herein, may be a value, level, rating, amount, quantity, capacity, lifetime, or the like for a particular constrained resource where, based on the current usage rate and the forecasted remaining utility of a resource, the action module 206 and/or the user should take an action to conserve the remaining utility of the constrained resource.

For instance, in one embodiment, the utility threshold comprises a network data usage threshold, e.g., 90 Gbs used of a 100 Gb limit/cap. In such an embodiment, the action module 206 may perform an action such as presenting a different network to connect to (e.g., a Wi-Fi network instead of a mobile/cellular network), presenting a summary of an amount of network data used as compared to network data available or amount of capacity under the current network cap, modifying the user's activity such that less network data is consumed (e.g., disconnecting the electronic device from the network, preventing the application from using network data, streaming videos or other multimedia content at a lower quality that uses less network data, and/or the like).

In another examiner embodiment, the utility threshold comprises a battery usage threshold, e.g., 10% battery life remaining. In such an embodiment, the action module 206 may perform an action such as modifying at least one setting on the electronic device such that it uses less battery (e.g., changing a brightness setting so that the display uses less battery, closing applications or services running in the background, turning off the electronic device's connection to a data network, pausing the user's activity on the electronic device, notifying the user of a remaining battery life based on the current usage rate, shutting down the electronic device, only allowing necessary applications to run on the electronic device, and/or the like.

In one embodiment, the action comprises displaying the forecasted remaining utility of the constrained resource in response to the forecasted remaining utility satisfying the utility threshold. For instance, the action module 206 may present a push notification, a pop-up, a text message, an instant message, a banner message, and/or other warning that gets the user's attention and notifies the user that, based on their current usage of the electronic device, the constrained resource will be unavailable/fully used within a calculated amount of time (which may also be presented, e.g., “battery will be dead in ten minutes if the current usage continues”) unless the user takes an action to preserve battery life (e.g., close applications, change a brightness settings, change network connectivity settings, and/or the like).

In certain embodiments, the action comprises generating a warning that the forecasted remaining utility will satisfy the utility threshold within a calculated amount of time based on the current usage rate of the user's activity on the electronic device. For example, the action module 206 may present a push notification that indicates that the battery will be dead, will be at 5%, will be at 10% or the like within 5 minutes, 10 minutes, 20 minutes, or the like based on the user's current usage of the electronic device. Similarly, the action module 206 may present a push notification that indicates that the user's network cap will be reached within 5 minutes, 10 minutes, or the like based on the user's current usage of the electronic device.

In one embodiment, the action comprises displaying at least one suggestion for modifying the user's activity on the electronic device to preserve the utility of the constrained resource. For example, the action module 206 may present a suggestion to change a display setting, to close one or more applications, to connect to a different network, to disconnect from the network, to turn the electronic device off, to expand storage space, to delete data (which may include suggestions for files or applications to delete, e.g., least recently used files or applications) to create available storage space, and/or the like.

In one embodiment, the at least one action and/or suggestion is determined based on at least one of the user's location, an upcoming event determined from a calendar, trends in the user's previous actions related to the constrained resource, and/or the like. For instance, the action may be a suggestion to quit an application, dim a brightness, turn on a battery saver setting, and/or the like if the current usage rate of the battery exceeds the usage threshold and the user is not near a location where the user typically charges their electronic device, if the user has an upcoming meeting and needs to use their device during the meeting, and/or the like. Similarly, if the user typically plays an online game for thirty minutes, but the forecast module 204 determines that the network data usage of the game for thirty minutes would put the user over the user's network data cap, the action module 206 may notify the user of the remaining network data available until the cap is met and how much network data the user typically consumes while playing the game prior to, or in response to, the user executing the application.

In one embodiment, the action module 206 prevents an action from being taken in response to determining that an interruption exception is set for the user's activity on the electronic device. For instance, a user may set settings for applications that specify that the application should not be limited, paused, exited, quit, canceled, and/or the like and should be given full feature execution even if the forecasted remaining utility of the constrained resource satisfies the utility threshold.

In certain embodiments, the action comprises identifying and presenting at least one different device to continue the user's activity in response to the forecasted remaining utility of the constrained resource satisfying the utility threshold. For instance, if the user is watching videos on their smart phone, but the forecasted remaining utility of the constrained resource satisfies the utility threshold based on the current usage rate, the action module 206 may suggest, cast, automatically switch to, or the like the content to the user's tablet computer, laptop computer, smart television, and/or the like.

In one embodiment, the ML module 208 is configured to provide the current usage rate to a machine learning that is trained on the historical usage of the electronic device to forecast the remaining utility of the constrained resource. As used herein, machine learning may refer to a device's or a system's ability to automatically learn and improve from experience without being explicitly programmed. Machine learning focuses on the development of computer programs that can access data and use it to learn for themselves. Various machine learning algorithms may be employed including supervised or unsupervised learning algorithms, neural networks, and/or other deep learning algorithms.

In one embodiment, the ML module 208 trains one or more machine learning models on historical resource usage data for the electronic device, which the usage module 202 may track. The ML module 208 may refine, update, and/or the like the trained machine learning models using new, updated, and/or the like resource usage data while the user uses the electronic device. The forecast module 208 may provide current resource usage information, e.g., the current usage rate, the user's location, the user's calendar data, and/or the like as input into the machine learning models to determine, forecast, predict, estimate, and/or the like the forecasted remaining utility of the constrained resource, an amount of time that the constrained resource will last given the current usage rate, suggestions or recommendations for conserving the constrained resource (e.g., given the user's location, usage trends, calendar information, or the like), and/or the like.

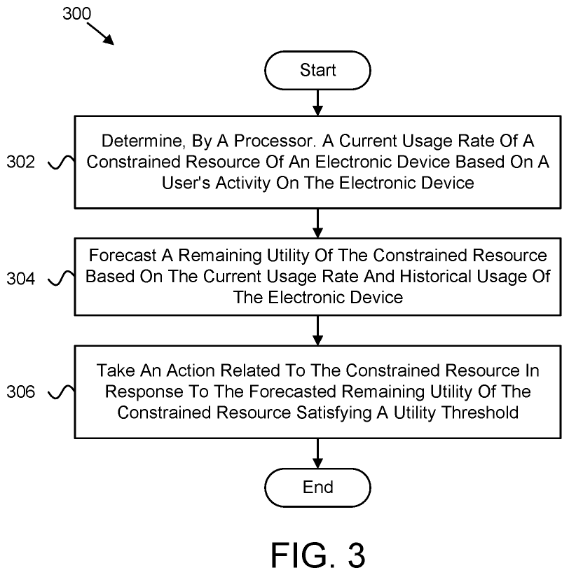

FIG. 3 is a schematic block diagram illustrating one embodiment of another apparatus 300 for dynamic mobile device resource management. In one embodiment, the method 300 begins and determines 302 a current usage rate of a constrained resource of an electronic device based on a user's activity on the electronic device. In some embodiments, the method 300 forecasts 304 a remaining utility of the constrained resource based on the current usage rate and historical usage of the electronic device.

In one embodiment, the method 300 takes 306 an action related to the constrained resource in response to the forecasted remaining utility of the constrained resource satisfying a utility threshold, and the method 300 ends. In various embodiments, the usage module 202, the forecast module 204, and the action module 206 perform the various steps of the method 300.

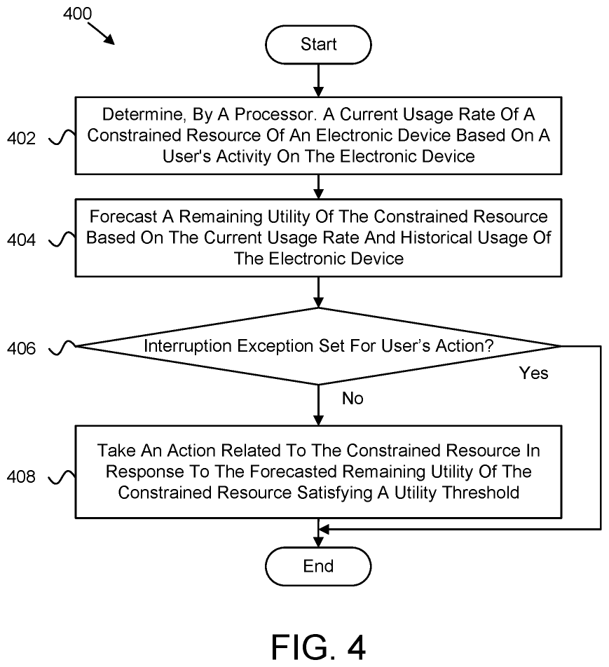

FIG. 4 is a schematic flow chart diagram illustrating one embodiment of a method 400 for dynamic mobile device resource management. In one embodiment, the method 400 begins and determines 402 a current usage rate of a constrained resource of an electronic device based on a user's activity on the electronic device. In some embodiments, the method 400 forecasts 404 a remaining utility of the constrained resource based on the current usage rate and historical usage of the electronic device.

In one embodiment, the method 400 determines 406 whether an interruption exception is set for the user's activity or use of the electronic device. If so, the method 400 ends. Otherwise, the method 400 takes 408 an action related to the constrained resource in response to the forecasted remaining utility of the constrained resource satisfying a utility threshold, and the method 400 ends. In various embodiments, the usage module 202, the forecast module 204, and the action module 206 perform the various steps of the method 400.

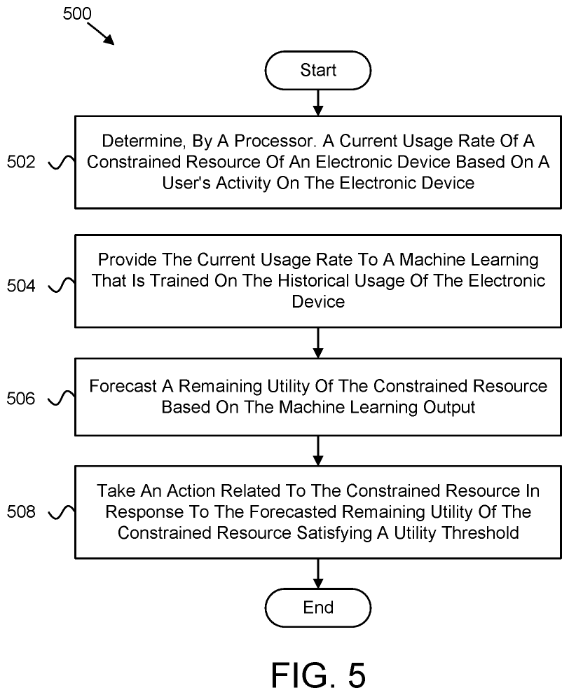

FIG. 5 is a schematic flow chart diagram illustrating one embodiment of a method 500 for dynamic mobile device resource management. In one embodiment, the method 500 begins and determines 502 a current usage rate of a constrained resource of an electronic device based on a user's activity on the electronic device. In some embodiments, the method 500 provides 504 the current usage rate to a machine learning that is trained on the historical usage of the electronic device.

In some embodiments, the method 500 forecasts 506 a remaining utility of the constrained resource based on the machine learning output. In one embodiment, the method 500 takes 508 an action related to the constrained resource in response to the forecasted remaining utility of the constrained resource satisfying a utility threshold, and the method 500 ends. In various embodiments, the usage module 202, the forecast module 204, the action module 206, and the ML module 208 perform the various steps of the method 500.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a processor; and
a memory that stores code executable by the processor to:
determine a current usage rate of a constrained resource of an electronic device based on a user's activity on the electronic device;
forecast a remaining utility of the constrained resource based on the current usage rate and historical usage of the electronic device; and
take an action related to the constrained resource in response to the forecasted remaining utility of the constrained resource satisfying a utility threshold.

2. The apparatus of claim 1, wherein the action comprises displaying the forecasted remaining utility of the constrained resource in response to the forecasted remaining utility satisfying the utility threshold.

3. The apparatus of claim 1, wherein the action comprises generating a warning that the forecasted remaining utility will satisfy the utility threshold within a calculated amount of time based on the current usage rate of the user's activity on the electronic device.

4. The apparatus of claim 1, wherein the action comprises displaying at least one suggestion for modifying the user's activity on the electronic device to preserve the utility of the constrained resource.

5. The apparatus of claim 4, wherein the at least one suggestion is determined based on at least one of the user's location, an upcoming event determined from a calendar, and trends in the user's previous actions related to the constrained resource.

6. The apparatus of claim 1, wherein the code is executable by the processor to prevent taking the action in response to determining that an interruption exception is set for the user's activity on the electronic device.

7. The apparatus of claim 1, wherein the action comprises identifying and presenting at least one different device to continue the user's activity in response to the forecasted remaining utility of the constrained resource satisfying the utility threshold.

8. The apparatus of claim 1, wherein the code is executable by the processor to provide the current usage rate to a machine learning that is trained on the historical usage of the electronic device to forecast the remaining utility of the constrained resource.

9. The apparatus of claim 1, wherein the constrained resource comprises at least one of battery life for the electronic device and network data usage for the electronic device.

10. The apparatus of claim 9, wherein the utility threshold comprises a network data usage threshold and the action comprises at least one of presenting a different network to connect to, presenting a summary of an amount of network data used as compared to network data available, and modifying the user's activity such that less network data is consumed.

11. The apparatus of claim 9, wherein the utility threshold comprises a battery usage threshold and the action comprises at least one of modifying at least one setting on the electronic device such that it uses less battery, pausing the user's activity on the electronic device, and notifying the user of a remaining battery life based on the current usage rate.

12. A method, comprising:
determining, by a processor, a current usage rate of a constrained resource of an electronic device based on a user's activity on the electronic device;
forecasting a remaining utility of the constrained resource based on the current usage rate and historical usage of the electronic device; and
taking an action related to the constrained resource in response to the forecasted remaining utility of the constrained resource satisfying a utility threshold.

13. The method of claim 12, wherein the action comprises displaying the forecasted remaining utility of the constrained resource in response to the forecasted remaining utility satisfying the utility threshold.

14. The method of claim 12, wherein the action comprises generating a warning that the forecasted remaining utility will satisfy the utility threshold within a calculated amount of time based on the current usage rate of the user's activity on the electronic device.

15. The method of claim 12, wherein the action comprises displaying at least one suggestion for modifying the user's activity on the electronic device to preserve the utility of the constrained resource, the at least one suggestion determined based on at least one of the user's location, an upcoming event determined from a calendar, and trends in the user's previous actions related to the constrained resource.

16. The method of claim 12, further comprising preventing taking the action in response to determining that an interruption exception is set for the user's activity on the electronic device.

17. The method of claim 12, wherein the action comprises identifying and presenting at least one different device to continue the user's activity in response to the forecasted remaining utility of the constrained resource satisfying the utility threshold.

18. The method of claim 12, further comprising providing the current usage rate to a machine learning that is trained on the historical usage of the electronic device to forecast the remaining utility of the constrained resource.

19. The method of claim 12, wherein the constrained resource comprises at least one of battery life for the electronic device and network data usage for the electronic device, the utility threshold comprising at least one of:
a network data usage threshold and the action comprises at least one of presenting a different network to connect to, presenting a summary of an amount of network data used as compared to network data available, and modifying the user's activity such that less network data is consumed; and
a battery usage threshold and the action comprises at least one of modifying at least one setting on the electronic device such that it uses less battery, pausing the user's activity on the electronic device, and notifying the user of a remaining battery life based on the current usage rate.

20. A computer program product, comprising a computer readable storage medium having program instructions embodied therewith, the program instructions executable by a processor to cause the processor to:
determine a current usage rate of a constrained resource of an electronic device based on a user's activity on the electronic device;
forecast a remaining utility of the constrained resource based on the current usage rate and historical usage of the electronic device; and
take an action related to the constrained resource in response to the forecasted remaining utility of the constrained resource satisfying a utility threshold.
